(19) United States
(12) Patent Application Publication
(10) Pub. No.: US 2023/0399579 A1
(43) Pub. Date: Dec. 14, 2023

(54) BIODEGRADABLE FRAGRANCE AND/OR FLAVOR-LOADED MICROCAPSULES

(71) Applicant: PHYTO TECH CORP., Rancho Santa Margarita, CA (US)

(72) Inventors: Cuie YAN, San Pedro, CA (US); Sangryoung KIM, Irvine, CA (US)

(21) Appl. No.: 18/332,586

(22) Filed: Jun. 9, 2023

Related U.S. Application Data
(60) Provisional application No. 63/351,241, filed on Jun. 10, 2022.

(51) Int. Cl. C11B 9/00; A61Q 13/00; A23P 10/35; A23L 27/00

(52) U.S. Cl. CPC C11B 9/00; A61Q 13/00; A23P 10/35; A23L 27/72; A23L 27/80

(57) ABSTRACT

This disclosure provides fragrance and/or flavor oil-loaded biodegradable microcapsules for use in food, beverage, cosmetical, personal care and household products. The disclosure also provides methods of making fragrance and/or flavor oil-loaded biodegradable microcapsules.

### BACKGROUND OF THE INVENTION

### Field of Invention

This disclosure provides fragrance and/or flavor-loaded biodegradable microcapsules for use in food, beverage, cosmetical, personal care and household products. The microcapsules may be used in mitigating the microplastic pollution challenge. The disclosure also provides methods of making biodegradable fragrance and/or flavor-loaded microcapsules.

### Background

Microplastic (MP) is widely detected in aquatic environments and attract increasing ecological concern worldwide. MPs have been found all over the Earth, including in the poles, and in environmental studies have revealed that public sewage treatment plants are a common pathway for MPs to reach local surroundings. Microplastics are becoming more of a worry, posing a danger to both marine wildlife and humans. MPs are smaller than 1000 microns and can be classified as primary or secondary based on their sources. Primary MPs are mainly produced directly from plastics and resin particles in cosmetical, personal care, and household products. Synthetic polymers for fragrance encapsulation are important sources of MPs. Commonly used fragrances and/or flavors include: mint family fragrances and/or flavors, e.g., peppermint; floral family fragrances and/or flavors, e.g., vanilla, rose, jasmine and lavender; fruity family fragrances and/or flavors, e.g., lemon, orange, mango, pineapple, lychee, raspberry, peach and strawberry; and woody family fragrances, e.g., musk oil.

Fragrances trigger powerful emotional memories, enable us to track food and water, find a mate and even communicate. Mint smell refreshes minds, soothes skin, relieves itch and pain. Fruity scents awaken and energize the mind. Floral scent can improve mood states. The sweet and nutty scents of vanilla are popular smells, as vanilla fragrance makes humans calm, warm and comforting. Woody scents like musk odor are one of the pheromones affecting human psychology, and are widely used in many consumer products, such as perfumes, deodorants, and detergents. Microplastics are commonly used to encapsulate fragrance and/or flavor oils. However, these microplastics may cause undesirable contamination of soil, water, marine organisms, and even human breast milk.

There exists a need for microencapsulation of fragrance and/or flavor oils in biodegradable materials.

### BRIEF SUMMARY OF THE INVENTION

In one aspect, the disclosure provides a biodegradable microcapsule comprising an inner core and a primary shell surrounding the inner core, wherein (i) the inner core comprises fragrance and/or flavor oils and, optionally, one or more food grade oils; and (ii) the primary shell comprises one or more food grade wall materials.

In another aspect, the disclosure provides a biodegradable microcapsule comprising: (a) an agglomeration of primary microcapsules, wherein the primary microcapsules comprise an inner core and a primary shell surrounding the inner core; and (b) an outer shell surrounding the agglomeration of primary microcapsules, wherein (i) the inner core comprises fragrance and/or flavor oils and, optionally, one or more food grade oils; (ii) the primary shell comprises one or more food grade wall materials; and (iii) the outer shell comprises one or more food grade wall materials.

These biodegradable microcapsules are referred to as “fragrance and/or flavor oil-loaded biodegradable microcapsules.” Because these biodegradable microcapsules comprise fragrance and/or flavor oils, they can be used in food, beverage, cosmetic, personal care and household, and other consumer products.

In another aspect, the disclosure provides an emulsion or agglomeration comprising a fragrance and/or flavor oil, optionally one or more food grade oils, one or more food grade wall materials, and water.

In another aspect, the disclosure provides a method of making fragrance and/or flavor oil-loaded biodegradable microcapsules, the method comprising (i) providing an emulsion or agglomeration comprising a fragrance and/or flavor oil, optionally one or more food grade oils, one or more food grade wall materials, water, and, optionally, one or more processing aids; and (ii) spray drying the emulsion or agglomeration to provide a powder comprising the microcapsules.

In another aspect, the disclosure provides a method of making a fragrance and/or flavor-loaded biodegradable microcapsule, the method comprising (i) providing an emulsion or agglomeration comprising a fragrance and/or flavor oil, one or more food grade wall materials, water, and, optionally, one or more processing aids; (ii) adjusting the pH, temperature, concentration, or mixing speed, or combination thereof, of the emulsion or agglomeration to form a coacervate slurry; and (iii) spray drying the coacervate slurry to provide a powder comprising the microcapsule.

### DETAILED DESCRIPTION OF THE INVENTION

### I. Biodegradable Microcapsules of the Disclosure

In one embodiment, the disclosure provides a biodegradable microcapsule comprising an inner core and a primary shell surrounding the inner core, wherein: (i) the inner core comprises a fragrance and/or flavor oil; and (ii) the primary shell comprises one or more food grade wall materials. This is referred to herein as single-core microcapsule.

In one embodiment, the disclosure provides a biodegradable microcapsule comprising: (a) an emulsion or agglomeration of primary microcapsules, wherein the primary microcapsules comprise an inner core and a primary shell surrounding the inner core; and (b) an outer shell surrounding the agglomeration of primary microcapsules, wherein (i) the inner core comprises a fragrance and/or flavor oil; (ii) the primary shell comprises one or more food grade wall materials; and (iii) the outer shell comprises one or more food grade wall materials by adjusting the pH, temperature, concentration, or mixing speed, or combination thereof, and the emulsion or agglomeration to form a coacervate slurry. This is referred to herein as a biodegradable multicore microcapsule.

Unless stated otherwise, the term “biodegradable microcapsule” as used herein refers to single-core, multicore, or a mixture of single-core and multicore microcapsules.

In another embodiment in connection with the biodegradable microcapsules disclosed herein, the food grade oil comprises coconut oil, palm oil, soy bean oil, mineral oil, olive oil, canola oil, avocado oil, sunflower oil, peanut oil, corn oil, walnut oil, flaxseed oil, sesame oil, almond oil, tea seed oil, grapeseed oil, safflower oil, hemp seed oil, or vegetable oil, or a combination thereof. In another embodiment, the food grade oil comprises palm oil or coconut oil.

A number of different food-grade polymers can be used as wall materials to produce the shell layers of the microcapsules disclosed herein. For example, the primary shell and/or outer shell may comprise a surfactant, gelatin, protein, polyphosphate, or polysaccharide, or mixtures thereof. Further examples of suitable wall materials for the primary shell and/or outer shell include, but are not limited to, gelatin type A, gelatin type B, polyphosphate, gum arabic, alginate, chitosan, carrageenan, pectin, low-methoxyl-pectin, starch, modified starch, alpha-lactalbumin, beta-lactoglobumin, ovalbumin, polysorbiton, maltodextrin, cyclodextrin, cellulose, methyl cellulose, ethyl cellulose, hydropropylmethylcellulose, carboxymethylcellulose, milk protein, whey protein, soy protein, canola protein, albumin, chitin, polylactides, poly-lactide-co-glycolides, derivatized chitin, poly-lysine, kosher gelatin, non-kosher gelatin, Halal gelatin, and non-Halal gelatin, including combinations and mixtures thereof. Derivatives of these polymers can also be used. One specific type of wall material that can be used in the disclosed microcapsules is fish gelatin or pork gelatin.

The primary shell and/or outer shell layers can have, for example, a Bloom number of from about 0 to about 350. The Bloom number describes the gel strength formed at 10° C. with a 6.67% solution gelled for 17±1 hours. Determining the Bloom number of a substance can be accomplished by methods known in the art. It is contemplated that the primary shell and/or outer shell material can have a Bloom number of about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 60, 61, 62, 63, 64, 65, 66, 67, 68, 69, 70, 70, 71, 72, 73, 74, 75, 76, 77, 78, 79, 80, 80, 81, 82, 83, 84, 85, 86, 87, 88, 89, 90, 90, 91, 92, 93, 94, 95, 96, 97, 98, 99, 100, 100, 101, 102, 103, 104, 105, 106, 107, 108, 109, 110, 110, 111, 112, 113, 114, 115, 116, 117, 118, 119, 120, 120, 121, 122, 123, 124, 125, 126, 127, 128, 129, 130, 130, 131, 132, 133, 134, 135, 136, 137, 138, 139, 140, 140, 141, 142, 143, 144, 145, 146, 147, 148, 149, 150, 150, 151, 152, 153, 154, 155, 156, 157, 158, 159, 160, 160, 161, 162, 163, 164, 165, 166, 167, 168, 169, 170, 170, 171, 172, 173, 174, 175, 176, 177, 178, 179, 180, 180, 181, 182, 183, 184, 185, 186, 187, 188, 189, 190, 190, 191, 192, 193, 194, 195, 196, 197, 198, 199, 200, 200, 201, 202, 203, 204, 205, 206, 207, 208, 209, 210, 210, 211, 212, 213, 214, 215, 216, 217, 218, 219, 220, 220, 221, 222, 223, 224, 225, 226, 227, 228, 229, 230, 230, 231, 232, 233, 234, 235, 236, 237, 238, 239, 240, 240, 241, 242, 243, 244, 245, 246, 247, 248, 249, 250, 250, 251, 252, 253, 254, 255, 256, 257, 258, 259, 260, 260, 261, 262, 263, 264, 265, 266, 267, 268, 269, 270, 270, 271, 272, 273, 274, 275, 276, 277, 278, 279, 280, 280, 281, 282, 283, 284, 285, 286, 287, 288, 289, 290, 290, 291, 292, 293, 294, 295, 296, 297, 298, 299, 300, 300, 301, 302, 303, 304, 305, 306, 307, 308, 309, 310, 310, 311, 312, 313, 314, 315, 316, 317, 318, 319, 320, 320, 321, 322, 323, 324, 325, 326, 327, 328, 329, 330, 330, 331, 332, 333, 334, 335, 336, 337, 338, 339, 340, 340, 341, 342, 343, 344, 345, 346, 347, 348, 349, or 350, where any of the stated values can form an upper or lower end point where appropriate. In some specific examples, the primary and/or outer shell material can have a Bloom number of from about 0 to about 50, and in other examples, the primary and/or outer shell material can have a Bloom number of from about 51 to about 350. Still other specific examples include microcapsules comprising a primary shell and/or outer shell material having a Bloom number of about 0, about 210, about 220, or about 240. In one example, the microcapsule does not contain “low Bloom” gelatin, which is gelatin having a Bloom number less than 50.

The shell layer can be a two-component system made from a mixture of different types of food-grade polymer components, and where a composition has been added to the system to improve impermeability. In other examples, the shell material can be a complex coacervate between two or more components, e.g., gelatin A and polyphosphate. For example, component A can be gelatin type A, although other polymers like those mentioned above for the shell materials are also contemplated as component A. Component B can be gelatin type B, polyphosphate, gum arabic, alginate, chitosan, carrageenan, pectin, low-methoxyl-pectin, carboxymethyl-cellulose or a mixture thereof other polymers like those disclosed above for the shell materials are also contemplated as component B. The molar ratio of component A:component B that is used depends on the type of components but is typically from about 1:5 to about 15:1. For example, when gelatin type A and polyphosphate are used as components A and B respectively, the molar ratio of component A:component B can be about 8:1 to about 12:1; when gelatin type A and gelatin type B are used as components A and B respectively, the molar ratio of component A:component B can be about 2:1 to about 1:2; and when gelatin type A and alginate are used as components A and B respectively, the molar ratio of component A:component B can be about 3:1 to about 5:1. In some embodiments, the primary shell and/or outer shell of the microcapsule comprises a complex coacervate. For example, the primary shell and/or outer shell can comprise a complex coacervate of gelatin and polyphosphate. Other examples include a complex coacervate of gelatin and alginate, gelatin and pectin, gelatin and gum arabic, gelatin and xanthan, gelatin and low methoxyl pectin, and gelatin and whey protein.

In the disclosed multi-core microcapsules, the microcapsules can have an average diameter of from about 1 μm to about 2,000 μm, from about 20 μm to about 1,000 μm, or from about 30 μm to about 80 μm. In further examples, the average diameter can be about 1, 10, 20, 30, 40, 50, 60, 70, 80, 90, 200, 300, 400, 500, 600, 700, 800, 900, 1000, 1200, 1300, 1400, 1500, 1600, 1700, 1800, 1900, or 2000 μm, where any of the stated values can form an upper or lower endpoint when appropriate.

The outer shell of the microcapsules disclosed herein can have an average diameter of from about 40 nm to about 10 μm or from about 0.1 μm to about 5 μm. In further examples, the average diameter of the outer shell can be about 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1000 nm, 2 μm, 3 μm, 4 μm, 5 μm, 6 μm, 7 μm, 8 μm, 9 μm, 10 μm, where any of the stated values can form an upper or lower endpoint when appropriate. Particle size can be measured using any typical equipment known in the art, for example, a Coulter LS230 Particle Size Analyzer, Miami, Fla., USA.

The biodegradable microcapsules disclosed herein can have a shell(s) (primary and/or outer) that contains one or more additional “shell-stabilizing agents” to improve the impermeability and other properties of the microcapsule. These shell-stabilizing agent(s) can be incorporated into the shell(s) at any point along the microcapsule preparation process. In general, the shell-stabilizing agent(s) can be associated with the shell(s) through physical, electrostatic, ionic, van der Waals, steric, or chemical interactions. For example, the shell-stabilizing agent(s) can be physically be trapped inside a pore present in a shell, thus blocking the pore. In another example, the shell-stabilizing agent(s) can be chemically bonded to the shell material through a covalent bond, e.g., through an enzymatically catalyzed crosslinking reaction.

Specific examples of shell-stabilizing agent(s) that can be present in a shell(s) (primary and/or outer) of the disclosed microcapsules include, but are not limited to, amino acids, peptides, proteins, saccharides (i.e., mono-, di-, oligo-, or polysaccharides), and waxes, including combinations thereof and residues thereof. To illustrate further, a polysaccharide chitosan can be present in the shells of the disclosed microcapsules and can participate in an enzymatically crosslinking reaction between the polymer components that are used to produce the shell material. The chitosan, with its multiple crosslinking sites, can thus be chemically bonded to the other polymer components in the shell material and thereby increase the shell's impermeability. In other examples, a small molecule like an amino acid or sugar can be physically trapped, entangled, or even chemically bonded to the shell(s) of a microcapsule, thus acting to reinforce the shell and/or block any pores. Larger wax particles and proteins can also be incorporated into a microcapsule shell to strengthen, reinforce, and/or improve impermeability by blocking any pores.

Any combination of one or more suitable shell-stabilizing agents can be used and can be present in the shell material of the microcapsules disclosed herein. These include, for example, one or more amino acids, one or more proteins, one or more peptides, one or more saccharides, or one or more waxes can be used. Further, one or more amino acids and proteins, one or more amino acids and saccharides, or one or more amino acids and waxes can be used. Still further, one or more proteins and saccharides, or one or more proteins and waxes can be used. Also, one or more saccharides and waxes can be used. In yet another example, one or more amino acids, proteins, and saccharides, one or more amino acids, proteins, and waxes, one or more proteins, saccharides and waxes, one or more amino acids, saccharides, and waxes can be used.

Specific examples of amino acids, including residues thereof, that can be used in the disclosed microcapsule shell(s) include, for example, the 20 naturally encountered amino acids that make up proteins and polypeptides. In addition, it further includes less typical constituents which are both naturally occurring, such as, but not limited to formylmethionine and selenocysteine, analogs of typically found amino acids, and mimetics of amino acids or amino acid functionalities. Also contemplated are polymers of amino acids such as polylysine. Shell-stabilizing agent(s) may comprise, for example, lysine, leucine, isoleucine, glutamine, methionine, tyrosine, phenylalanine, tyrosine, tryptophan, or cysteine or any combination thereof. Amino acids can be present in the shell material at a ratio of from about 1:5 to about 5:1, e.g., about 2:1, in comparison to the polymer component(s). Further examples include microcapsules with an amino acid to polymer component ratio of about 1:5, 1:4, 1:3, 1:2, 1:1, 2:1, 3:1, 4:1, and 5:1, where any ratio can form an upper or lower endpoint of a range of ratios.

Suitable proteins and peptides are compounds composed of amino acids chemically bound together. In general, the amino acids are chemically bound together via amide linkages (—CONH—); however, the amino acids may be bound together by other chemical bonds known in the art. For example, the amino acids can be connected by amine linkages. It is also possible to use peptides and proteins linked to other molecules, e.g., conjugates. For example, carbohydrates, e.g., glycoproteins, can be linked to the protein or peptide. Such derivatives, variants, and analogs of peptides and proteins are contemplated herein within the meaning of protein. Some specific proteins include, but are not limited to, milk protein, gelatin, whey protein isolate, whey protein concentrate, caseinate, soy protein, BSA, and other albumen, including mixtures thereof. The proteins can be present in the shell material at a ratio to the second polymer component of from about 1:1 to about 40:1 (e.g., about 28.5:1). Further examples include microcapsules with a protein to second polymer component ratio of about 1:1, 5:1, 10:1, 15:1, 20:1, 25:1, 30:1, 35:1, and 40:1, where any ratio can form an upper or lower endpoint of a range of ratios.

Also suitable are food-grade polymeric amines, which are olefin-based polymers containing one or more amine functional groups. Many such polyamines can be obtained commercially or can be prepared by methods known in the art. Suitable examples of polyamines that can used as a first active substance in the disclosed cellulose/active substance composites include, but are not limited to, polyvinyl amine and polyalkyleneimines like polyethyleneimine.

Saccharides, including residues thereof, are also suitable shell-stabilizing agents that can be present in the disclosed microcapsule shells. Specific examples include N-acetylglucosamine polymer, such as chitosan and chitin. Chitosan is a naturally occurring polymer found in many fungi. However, as a matter of convenience, chitosan is obtained from chitin, which (after cellulose) is the second most abundant natural polymer. Chitin is readily isolated from shellfish or insect exoskeletons, and is also found in mollusks and fungi. Chitin is a water-insoluble copolymer of N-acetyl-D-glucosamine and D-glucosamine, but the great preponderance of monomer units are N-acetyl-D-glucosamine residues. Chitosan is a copolymer of the same two monomer units, but the preponderance of monomer units are D-glucosamine residues. Since the D-glucosamine residues bear a basic amino function, they readily form salts with acids. Many of these salts are water soluble. Treatment of chitin with concentrated caustic at elevated temperature converts N-acetyl-D-glucosamine residues into D-glucosamine residues and thereby converts chitin into chitosan. There is a continuum of compositions possible between pure poly-N-acetyl-D-glucosamine and pure poly-D-glucosamine. These compositions are all within the skill of the art to prepare and are all suitable for the uses described herein.

Suitable acids for making the chitosan salts for use in the methods described herein are those acids that form water-soluble salts with chitosan. It is not necessary that the acid itself be water-soluble; however, such water-soluble acids can ease handling. Inorganic acids, which form water-soluble chitosan salts, include the halogen acids and nitric acid, but exclude sulfuric and phosphoric acids because they do not form water-soluble salts with chitosan. Organic acids are particularly suitable and include, but are not limited to, lactic acid, glycolic acid, glutamic acid, formic acid, acetic acid, and a mixture thereof. Either mono- or poly-functional carboxylic acids can also be used. They can be aliphatic or aromatic, so long as they form water-soluble salts with chitosan.

Other polysaccharides and residues thereof that are suitable saccharides for the disclosed microcapsules are maltodextrin (DE18, DE 21, DE40 etc.), modified starch (N-LOK), oligofructans, cyclodextrins (alpha-, beta- and gamma-cyclodextrins), carboxymethylcellulose, hydroxypropylmethylcellulose (HPMC) (Methocel), ethylcellulose (Ethocel), hydroxypropyl cellulose (HPC) (e.g., Klucel), cellulose ether (e.g., Benecel), agar, alginate, pectin, low-methoxyl-pectin, gum arabic, carrageenan, cellulose gum, dilutan gum, gellan gum, locus bean gum, welan gum, and xanthan gum.

Other suitable saccharides, including residues thereof, are monosaccharides such as glucose, fructose, galactose, arabinose, ribose, ribulose, xylose, mannose, and xylulose. Still further, suitable saccharides, including residues thereof, include disaccharides or trisaccharides where the saccharide exists in the form of a pyranose or furanose (6 or 5 member rings). Non-limiting examples of di- and tri-saccharides include sucrose, lactose, cellobiose, sorbose, cellotriose, trehalose, maltose, and raffinose and the like. Particularly useful forms of saccharides that can be used are maple syrup, honey, and corn syrup, which are safe and can add flavor to the microcapsules. Various saccharide derivatives such as xylitol, sorbitol, isomalt, and glucosamine are also suitable for use in the disclosed microcapsules.

The saccharides disclosed herein can be present in the shell material at a ratio to the total shell material, e.g., first and second polymer components, of from about 1:0.2 to about 1:5 or about 1:0.02 to 1:0.5 the ratio to the second polymer component (e.g., polyphosphate). Further examples include microcapsules with a saccharide to total polymer component ratio of about 1:0.2, 1:0.5, 1:1, 1:1.5, 1:2.0, 1:2.5, 1:3.0, 1:3.5, 1:4.0, 1:4.5, and 1:5.0, where any ratio can form an upper or lower endpoint of a range of ratios. Still further examples include microcapsules with a saccharide to second polymer component ratio of about 1:0.02, 1:0.05, 1:0.1, 1:0.15, 1:0.2, 1:0.25, 1:0.3, 1:0.35, 1:0.4, 1:0.45, and 1:0.5, where any ratio can form an upper or lower endpoint of a range of ratios.

A suitable food-grade wax that can be present in the disclosed microcapsules shells is carnauba wax, which can be present in a microemulsion form. Other suitable waxes include, but are not limited to, candelilla, cersines, (synthetic) Japan wax, orange peel wax, rice bran wax, shellac, paraffin, montan, microcrystalline wax, polyethylene, and beeswax. The wax can be present in the shell material at a ratio to the second polymer component of from about 1:1 to about 1:10. (e.g., 1:6). Further examples include microcapsules with a wax to second polymer component ratio of about 1:1, 1:2, 1:3, 1:4, 1:5, 1:6, 1:7, 1:8, 1:9, and 1:10, where any ratio can form an upper or lower endpoint of a range of ratios.

In one embodiment in connection with the biodegradable microcapsules disclosed herein, the primary and/or outer shell comprises one or more food grade wall materials.

In another embodiment in connection with the biodegradable microcapsules disclosed herein, the primary and/or outer shell comprises one, two, three, four, or five food grade wall materials.

In another embodiment in connection with the biodegradable microcapsules disclosed herein, the primary and/or outer shell comprises one food grade wall material.

In another embodiment in connection with the biodegradable microcapsules disclosed herein, the primary and/or outer shell comprises two food grade wall materials.

In another embodiment in connection with the biodegradable microcapsules disclosed herein, the primary and/or outer shell comprises three food grade wall materials.

In another embodiment in connection with the biodegradable microcapsules disclosed herein, the primary and/or outer shell comprises four food-grade wall materials.

In another embodiment in connection with the microcapsules disclosed herein, the primary and/or outer shell comprises five food-grade wall materials.

In another embodiment in connection with the biodegradable microcapsules disclosed herein, the food grade wall material comprises modified starch, gum arabic, gelatin, pectin, lecithin, casein, caseinate, whey protein isolates, pea protein isolates, soy protein isolates, egg protein, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof. In another embodiment, the food grade wall material comprises gelatin, protein isolate, lecithin, modified starch, or gum arabic, or a combination thereof. In another embodiment, the food grade wall material comprises gelatin.

In another embodiment in connection with the biodegradable microcapsules disclosed herein, the inner core further comprises one or more processing aids.

In another embodiment in connection with the biodegradable microcapsules disclosed herein, the primary shell surrounding the inner core further comprises one or more processing aids.

In another embodiment in connection with the multi-core biodegradable microcapsules disclosed herein, the outer shell surrounding the agglomeration further comprises one or more processing aids.

In another embodiment in connection with the biodegradable microcapsules disclosed herein, the inner core, primary shell, and/or outer shell further comprise one or more processing aids.

In another embodiment in connection with the biodegradable microcapsules disclosed herein, the one or more processing aids comprise an antioxidant.

In another embodiment in connection with the biodegradable microcapsule disclosed herein, the antioxidant is ascorbic acid, rosemary extracts, ascorbyl palmitate, or tocopherols, or a mixture thereof. In another embodiment, the antioxidant is ascorbic acid.

In another embodiment in connection with the biodegradable microcapsules disclosed herein, the inner core further comprises a second fragrance and/or flavor oil. In another embodiment, the second fragrance and/or flavor oil is a mint family oil, e.g., peppermint; a floral family oil, e.g., vanilla, rose, jasmine and lavender; a fruity family oil, e.g., lemon, orange, mango, pineapple, lychee, raspberry, peach and strawberry; or a woody family oil, e.g., musk oil.

In another embodiment in connection with the biodegradable microcapsules disclosed herein, the primary shell surrounding the inner core and/or the outer shell surrounding the agglomerate comprises cross-linked food grade wall materials.

In another embodiment in connection with the biodegradable microcapsules disclosed herein, the shell surrounding the inner core and/or the outer shell surrounding the agglomerate comprises a complex coacervate of the food grade wall materials.

In another embodiment in connection with the biodegradable microcapsules disclosed herein, the diameter of the microcapsule is from about 1 μm to about 500 μm, e.g., from about 10 μm to about 300 μm, e.g., from about 20 μm to about 200 μm.

In another embodiment in connection with the biodegradable microcapsules disclosed herein, the microcapsule comprises from about 1 wt % to about 75 wt % of fragrance oil, such as vanilla, floral, lavender, lemon, orange, musk oil, etc. from about 3 wt % to about 20 wt % of fragrance oil, e.g., from about 5 wt % to about 15 wt % of fragrance oil. Unless stated otherwise, the term “microcapsule” as used herein refers to multicore, single-core, or a mixture of multicore and single-core microcapsules

The biodegradable microcapsules disclosed herein generally have a combination of structural strength, impermeability, and/or high payload of fragrance oil, such as mint family like peppermint; floral family, like vanilla, rose, jasmine and lavender; fruity family, like lemon, orange, mango, pineapple, lychee, raspberry, peach and strawberry; woody family like musk oil, etc.

The biodegradable microcapsules described in this section are collectively referred to as “Microcapsules of the Disclosure” (each individually referred to as a “Microcapsule of the Disclosure”).

### II. Emulsions of the Disclosure

In another embodiment, the disclosure provides an emulsion comprising fragrance oil, one or more food grade wall materials, and water.

In another embodiment in connection with the emulsion disclosed herein, the emulsion droplet size is about 2 μm or less.

In another embodiment in connection with the emulsion disclosed herein, the food grade wall material comprises modified starch, gum arabic, gelatin, pectin, lecithin, casein, caseinate, whey protein isolates, pea protein isolates, soy protein isolates, egg proteins, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof. In another embodiment, the food grade wall material comprises gelatin, protein isolate, lecithin, modified starch, or gum Arabic, or a combination thereof.

In another embodiment in connection with the emulsion disclosed herein, the emulsion further comprises one or more processing aids.

In another embodiment in connection with the emulsion disclosed herein, the one or more processing aids comprise an antioxidant.

In another embodiment in connection with the emulsion disclosed herein, the antioxidant is ascorbic acid, rosemary extracts, ascorbyl palmitate, or tocopherols, or a mixture thereof.

In another embodiment in connection with the microcapsules disclosed herein, the one or more processing aids comprise a transglutaminase enzyme.

### III. Methods of Making a Biodegradable Microcapsule of the Disclosure

In another embodiment, the disclosure provides a method of preparing a Biodegradable Microcapsule of the Disclosure, the method comprising: (i) providing an emulsion or agglomeration comprising fragrance and/or flavor oil, one or more food grade wall materials, water, and, optionally, one or more processing aids; and (ii) spray drying the emulsion or agglomeration to provide a powder comprising the microcapsule. This method is referred to as “Method A.”

In another embodiment, the disclosure provides a method of preparing a Biodegradable Microcapsule of the Disclosure, the method comprising: (i) providing an emulsion or agglomeration comprising fragrance and/or flavor oil, optionally one or more food grade oils, one or more food grade wall materials, water, and, optionally, one or more processing aids; (ii) adjusting the pH, temperature, concentration, or mixing speed, or combination thereof, of the emulsion or agglomeration to form a coacervate slurry; and (iii) spray drying the coacervate slurry to provide a powder comprising the microcapsule. This method is referred to as “Method B.”

In another embodiment in connection with Methods A and/or B, the food grade wall material comprises modified starch, gum arabic, gelatin, pectin, lecithin, casein, caseinate, whey protein isolates, pea protein isolates, soy protein isolates, egg proteins, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof. In another embodiment, the food grade wall material comprises gelatin, protein isolate, lecithin, modified starch, or gum Arabic, or a combination thereof.

In another embodiment in connection with Methods A and/or B, the emulsion or agglomeration comprises one or more processing aids.

In another embodiment in connection with Methods A and/or B, the one or more processing aids comprise an antioxidant.

In another embodiment in connection with Methods A and/or B, the antioxidant is ascorbic acid, rosemary extracts, ascorbyl palmitate, tocopherols, or a mixture thereof.

In another embodiment in connection with Method B, the one or more processing aids comprise a transglutaminase enzyme.

Biodegradable Microcapsules of the Disclosure can be prepared, for example, by a process that comprises providing an emulsion or agglomeration comprising fragrance and/or flavor oil, optionally one or more food grade oils, one or more food grade wall materials, water, and, optionally, one or more processing aids; adjusting pH, temperature, concentration, mixing speed, or a combination thereof to form an aqueous mixture comprising wall material, wherein the wall material comprises one or more food grade wall materials and surrounds the oil and optionally one or more food grade oils; cooling the aqueous mixture to a temperature above the gel point of the wall material until the wall material forms agglomerations; and further cooling the aqueous mixture to form an outer shell around the agglomeration of fragrance and/or flavor oil and optionally one or more food grade oils.

In the disclosed methods, an aqueous mixture of fragrance and/or flavor oil, one or more food grade oils, one or more food grade wall materials, and, optionally, one or more processing aids is formed. The aqueous mixture can be an emulsion or agglomeration.

In the processes for preparing biodegradable microcapsules disclosed herein, providing an emulsion or agglomeration of fragrance or flavor oil, optionally one or more food grade oils, one or more food grade wall materials, and, optionally, one or more processing aids can be accomplished by methods and apparatus known in the art, e.g., homogenization and high pressure/high shear pumps. For example, emulsification can take place by emulsifying at from about 500 to about 30,000 rpm. The emulsification step can be monitored by removing a sample of the mixture and analyzing it under such methods as microscopy, light scattering, turbidity, etc. Generally, emulsification can be performed until an average droplet size of less than about 2 μM, is obtained. Not wishing to be bound by theory, if high emulsification speeds are used, e.g., 5,000 to 20,000 rpm, the resultant droplet size is usually small, e.g., from 0.5 to 2 μm. These small droplets can have higher surface energy and can readily form agglomerations when pH and/or temperature or concentration is adjusted accordingly. Particle size can be measured using typical equipment known in the art, for example, a COULTER™ LS230 Particle Size Analyzer.

The emulsification step can be performed at temperature of about 0° C. to about 60° C., e.g., at 5, 10, 15, 20, 30, 37, 40, 50, or 60° C. Specific examples include emulsifying the mixture at from about 10° C. to about 60° C. or from about 30° C. to about 50° C.

One or more processing aids can also be added to the emulsion, agglomeration and/or aqueous mixture. Such processing aids can be added before, during, and/or after the emulsion or agglomeration is provided.

Exemplary processing aids include, but art not limited to, antioxidants, surfactants, and/or chelators.

The pH, temperature, concentration, or mixing speed, or a combination thereof can be adjusted to form coacervates comprising one or more food grade wall materials, wherein the one or more food grade wall materials surround the inner core materials, i.e., the fragrance and/or flavor oil and optionally one or more food grade oils. If there is more than one food grade wall material, i.e., a first and s second food grade wall material are different, complex coacervation may occur between the components to form a coacervate, which further deposits around the inner core materials to form the shell. The pH adjustment depends, for example, on the type of wall material to be formed. For example, the pH may be adjusted to a value from about 3.5 to about 5.0, or from about 4.0 to about 5.0. If the pH of the mixture starts in the desired range, then little or no pH adjustment is required. In one example, the pH is adjusted to from about 3.5 to about 4.5, from about 3.6 to about 4.4, or from about 3.7 to about 4.2.

The initial temperature of the aqueous mixture can be from about 0° C. to about 60° C., or about 10° C. to about 60° C.

Mixing can be adjusted so that there is suitable mixing without breaking the microcapsules as they form. Particular mixing parameters depend on the type of equipment being used. Any of a variety of types of mixing equipment known in the art may be used. In one example, an axial flow impeller, such as LIGHTNIN™ A310 or A510, can be used. The shell of the disclosed microcapsules can comprise a complex coacervate. The complex coacervate can be formed from the two or more food grade wall materials. For example, the outer shell can comprise a complex coacervate between whey protein isolate and agar. All combinations of two or more food grade wall materials are contemplated herein for the complex coacervate and the shell.

The aqueous mixture can be cooled at a controlled cooling rate and mixing parameters to permit agglomeration of the primary shells to form encapsulated agglomerations of primary shells. Not wishing to be bound by theory, the encapsulated agglomerations are discrete particles themselves. It is advantageous to control the formation of the encapsulated agglomerations at a temperature below the gel point of the shell material, and to let excess shell material form a thicker shell. It is also possible at this stage to add more polymer (e.g., a third polymer component), where the polymer is the same or different as the shell material being used, in order to thicken the shell and/or produce microcapsules having primary and outer shells of different composition. The outer shell encapsulates the agglomeration of primary shells. Cooling the aqueous mixture can be accomplished by methods known in the art, e.g., the use of a chiller. The rate of cooling can be about 1° C. per minute to about 1° C. per about 100 minutes. For example, the rate of cooling can be about 1° C. per about 1, 5, 10, 15, 20, 25, 30, 35, 40, 45, 50, 55, 60, 65, 70, 75, 80, 85, 90, 95, or 100 minutes, where any of the stated values can form an upper or lower endpoint when appropriate. In specific examples, the rate of cooling can be about 1° C./5 minutes. Cooling can take place until the mixture reaches a temperature of from about 5° C. to about 25° C., e.g., about 5° C.

Processing aids can be included in the shell material. Processing aids can be used for a variety of reasons. For example, they may be used to promote agglomeration of the microcapsules, stabilize the emulsion system, improve the properties of the shell, control microcapsule size, and/or to act as an antioxidant. In one aspect, the processing aid can be an emulsifier, a fatty acid, a lipid, a wax, a microbial cell, e.g., yeast cell lines, a clay, or an inorganic compound, e.g., calcium carbonate. Not wishing to be bound by theory, these processing aids can improve the barrier properties of the microcapsules.

In one embodiment, one or more antioxidants are added to the shell material. Antioxidant properties are useful both during the process, e.g., during coacervation and/or spray drying, and in the microcapsules after they are formed, e.g., to extend shelf-life or the microcapsule. Preferably, a small number of processing aids that perform a large number of functions can be used. In one aspect, the antioxidant can be a phenolic compound, a plant extract, or a sulfur-containing amino acid. In one aspect, ascorbic acid or citric acid can be used to promote agglomeration of the microcapsules, to control microcapsule size, and to act as an antioxidant. The antioxidant can be used in an amount of about 100 ppm to about 20,000 ppm, or from about 1,000 ppm to about 5,000 ppm.

In the disclosed biodegradable microcapsules, the shell material can also be cross-linked. Thus, the disclosed methods can further involve the addition of a cross-linker. The cross-linker can be added to increase the rigidity of the microcapsules by cross-linking the shell material in the shell and to make the shells insoluble in both aqueous and oily media. In one example, the cross-linker is added after the shell of the microcapsule is produced. Any suitable cross-linker can be used and the choice of cross-linker can vary depending upon the selection of the first and second polymer component. In another example, the cross-linkers can be enzymatic cross-linkers, e.g. transglutaminase, aldehydes, e.g. formaldehyde or glutaraldehyde, tannic acid, or alum, or a mixture thereof.

In another embodiment, the cross-linker can be a plant extract or a phenolic compound. It is also contemplated that one or more processing aids, e.g., antioxidants, can be used with the cross-linker. When the microcapsules are to be used in a formulation that is to be delivered to a human, the cross-linkers are preferably non-toxic or of sufficiently low toxicity. The amount of cross-linker used depends on the components selected and can be adjusted to provide more or less structural rigidity as desired. In one embodiment, the amount of cross-linker used is in the amount of about 0.1% to about 5.0%, about 0.5% to about 5.0%, about 1.0% to about 5.0%, about 2.0% to about 4.0%, or about 2.5%, by weight, of one of the food grade wall materials. In general, one skilled in the art can determine the desired amount in any given case by experimentation. The cross-linker can be added at any stage of the process, e.g., it can be added after the cooling step. Further, in some applications, the use of transglutaminase to crosslink the microcapsules may not be desired because the temperature and pH are too low for effective cross-linking. Thus, glutaraldehyde can be in the disclosed methods to cross-link the disclosed microcapsules. In certain examples, the use of one or more compositions comprising an amino acid or protein, can react with residual glutaraldehyde that was totally or partially unreacted from the crosslinking reaction. That is, unreacted and partially-reacted glutaraldehyde, i.e., with one aldehyde group still reactive, can be neutralized by the amino group of lysine or other amino groups on proteins. In this sense, the microcapsules comprising amino acids and/or proteins can improve the microcapsule shell by filling any pores and neutralizing glutaraldehyde from the crosslinking reaction. This can also eliminate the need to wash the microcapsule after crosslinking because the microcapsule will be essentially free of glutaraldehyde. Crosslinking can also be accomplished with genipin, e.g., with genipin and carboxylmethyl chitosan, and/or other cross-linking agents.

In one embodiment, the disclosed microcapsules are washed with water and/or dried to provide a free-flowing powder. Thus, the disclosed methods of preparing microcapsules can comprise a drying step for the microcapsules. Drying can be accomplished by a number of methods known in the art such as, for example, freeze drying, drying with ethanol, or spray drying.

In one embodiment, spray drying is used for drying the microcapsules. Spray drying techniques are well known in the art, see, e.g., disclosed in “Spray Drying Handbook”, K. Masters, 5th edition, Longman Scientific Technical UK, 1991, the disclosure of which is hereby incorporated by reference at least for its teaching of spray drying methods. Drying agents or anticaking agents can be used to help produce free flowing powders.

### IV. Products-by-Process

In another embodiment, the disclosure provides a biodegradable microcapsule comprising: (a) an emulsion or agglomeration of primary microcapsules, wherein the primary microcapsules comprise an inner core and a primary shell surrounding the inner core; and (b) an outer shell surrounding the agglomeration of primary microcapsules, wherein (i) the inner core comprises fragrance and/or flavor oil; (ii) the primary shell comprises one or more food grade wall materials; and (iii) the outer shell comprises one or more food grade wall materials, wherein the biodegradable microcapsule is produced by spray drying the emulsion or agglomeration to provide a dry powder comprising the microcapsule. The microcapsule prepared by this process is referred to as “Product A.”

In another embodiment, the disclosure provides a biodegradable microcapsule comprising: (a) an emulsion or agglomeration of primary microcapsules, wherein the primary microcapsules comprise an inner core and a primary shell surrounding the inner core; and (b) an outer shell surrounding the agglomeration of primary microcapsules, wherein (i) the inner core comprises fragrance and/or flavor oil; (ii) the primary shell comprises one or more food grade wall materials; and (iii) the outer shell comprises one or more food grade wall materials, produced by adjusting the pH, temperature, concentration, or mixing speed, or combination thereof, of the emulsion or agglomeration to form a coacervate slurry; and (c) spray drying the coacervate slurry to provide a powder comprising the microcapsule. The microcapsule prepared by this process is referred to as “Product B.”

In another embodiment in connection with Products A and/or B, the food grade wall material comprises modified starch, gum arabic, gelatin, pectin, lecithin, casein, caseinate, whey protein isolates, pea protein isolates, soy protein isolates, egg proteins, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof. In another embodiment, the food grade wall material comprises gelatin, protein isolate, lecithin, modified starch, or gum arabic, or a combination thereof.

In another embodiment in connection with Products A and/or B, the emulsion comprises one or more processing aids.

In another embodiment in connection with Products A and/or B, the one or more processing aids comprise an antioxidant.

In another embodiment in connection with Products A and/or B, the antioxidant is ascorbic acid, rosemary extracts, ascorbyl palmitate, tocopherols, or a mixture thereof.

In another embodiment in connection with Product B, the one or more processing aids comprise a transglutaminase enzyme.

### V. Particular Embodiments

The disclosure provides the following particular embodiments.

Embodiment 1. A biodegradable microcapsule comprising: (a) an emulsion or agglomeration of primary microcapsules, wherein the primary microcapsules comprise an inner core and a primary shell surrounding the inner core; wherein the inner core comprises fragrance and/or flavor oil and; (ii) the primary shell comprises one or more food grade wall materials; and (iii) the outer shell comprises one or more food grade wall materials.

Embodiment 2. The biodegradable microcapsule of Embodiment 1, wherein the food grade wall material comprises modified starch, gum arabic, gelatin, pectin, lecithin, casein, caseinate, whey protein isolates, pea protein isolates, soy protein isolates, egg protein, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof.

Embodiment 3. The biodegradable microcapsule of Embodiment 2, wherein the food grade wall material comprises gelatin, protein isolate, lecithin, modified starch, or gum Arabic, or a combination thereof.

Embodiment 4. The biodegradable microcapsule of any one of Embodiments 1-3, wherein the inner core, the primary shell, and/or the outer shell further comprise one or more processing aids.

Embodiment 5. The biodegradable microcapsule of Embodiment 4, wherein the one or more processing aids comprise an antioxidant.

Embodiment 6. The biodegradable microcapsule of Embodiment 5, wherein the antioxidant is ascorbic acid, rosemary extracts, ascorbyl palmitate, or tocopherols, or a mixture thereof

Embodiment 7. The biodegradable microcapsule of any one of Embodiments 1-6, wherein the primary shell and/or the outer shell comprises cross-linked food grade wall materials.

Embodiment 8. The biodegradable microcapsule of any one of Embodiments 1-6, wherein the primary shell and/or the outer shell comprises a complex coacervate of the food grade wall materials.

Embodiment 9. The biodegradable microcapsule of any one of Embodiments 1-8, wherein the diameter of the microcapsule is from about 1 μm to about 500 μm.

Embodiment 10. The biodegradable microcapsule of any one of Embodiments 1-9, wherein the microcapsule comprises from about 1 wt % to about 60 wt % of fragrance and/or flavor oil.

Embodiment 11. An emulsion comprising fragrance and/or flavor oil, one or more food grade wall materials, and water.

Embodiment 12. The emulsion of Embodiment 11, wherein the emulsion droplet size is about 2 μm or less.

Embodiment 13. The emulsion of Embodiment 11 or 12, wherein the food grade wall material comprises modified starch, gum arabic, gelatin, pectin, lecithin, casein, caseinate, whey protein isolates, pea protein isolates, soy protein isolates, egg proteins, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof.

Embodiment 14. The emulsion of Embodiment 13, wherein the food grade wall material comprises gelatin, protein isolate, lecithin, modified starch, or gum Arabic, or a combination thereof

Embodiment 15. The emulsion of any one of Embodiments 11-14, further comprising one or more processing aids.

Embodiment 16. The emulsion of Embodiment 15, wherein the one or more processing aids comprise an antioxidant.

Embodiment 17. The emulsion of Embodiment 16, wherein the antioxidant is ascorbic acid, rosemary extracts, ascorbyl palmitate, or tocopherols, or a mixture thereof

Embodiment 18. A method of preparing the biodegradable microcapsule of Embodiment 1, the method comprising: (i) providing an emulsion or agglomeration comprising fragrance and/or flavor oil, one or more food grade wall materials, water, and, optionally, one or more processing aids; and (ii) spray drying the emulsion or agglomeration to provide a powder comprising the microcapsule.

Embodiment 19. A method of preparing the biodegradable microcapsule of Embodiment 1, the method comprising: (i) providing an emulsion or agglomeration comprising fragrance and/or flavor oil, one or more food grade wall materials, water, and, optionally, one or more processing aids; (ii) adjusting the pH, temperature, concentration, or mixing speed, or combination thereof, of the emulsion or agglomeration to form a coacervate slurry; and (iii) spray drying the coacervate slurry to provide a powder comprising the microcapsule.

Embodiment 20. The method of Embodiment 18 or 19, wherein the food grade wall material comprises modified starch, gum arabic, gelatin, pectin, lecithin, casein, caseinate, whey protein isolates, pea protein isolates, soy protein isolates, egg proteins, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof.

Embodiment 21. The method of Embodiment 20, wherein the food grade wall material comprises gelatin, protein isolate, lecithin, modified starch, or gum Arabic, or a combination thereof.

Embodiment 22. The method of any one of Embodiments 18-21, wherein the emulsion or agglomeration comprises one or more processing aids.

Embodiment 23. The method of Embodiment 22, wherein the one or more processing aids comprise an antioxidant.

Embodiment 24. The method of Embodiment 23, wherein the antioxidant is ascorbic acid, rosemary extracts, ascorbyl palmitate, tocopherols, or a mixture thereof.

Embodiment 25. The method of any one of Embodiments 18-24, wherein the one or more processing aids comprise a transglutaminase enzyme.

Embodiment 26. A biodegradable microcapsule comprising: (a) an emulsion or agglomeration of primary microcapsules, wherein the primary microcapsules comprise an inner core and a primary shell surrounding the inner core; wherein (i) the inner core comprises fragrance and/or flavor oil; (ii) the primary shell comprises one or more food grade wall materials; wherein the biodegradable microcapsule is produced by spray drying the emulsion or agglomeration to provide a dry powder comprising the microcapsule.

Embodiment 27. A biodegradable microcapsule comprising: (a) an emulsion or agglomeration of primary microcapsules, wherein the primary microcapsules comprise an inner core and a primary shell surrounding the inner core; and (b) an outer shell surrounding the agglomeration of primary microcapsules, wherein (i) the inner core comprises fragrance and/or flavor oil; (ii) the primary shell comprises one or more food grade wall materials; and (iii) the outer shell comprises one or more food grade wall materials, produced by adjusting the pH, temperature, concentration, or mixing speed, or combination thereof, of the emulsion or agglomeration to form a coacervate slurry; and (c) spray drying the coacervate slurry to provide a powder comprising the microcapsule.

Embodiment 28. The biodegradable microcapsule of Embodiment 26 or 27, wherein the food grade wall material comprises modified starch, gum arabic, gelatin, pectin, lecithin, casein, caseinate, whey protein isolates, pea protein isolates, soy protein isolates, egg proteins, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof.

Embodiment 29. The biodegradable microcapsule of Embodiment 28, wherein the food grade wall material comprises gelatin, protein isolate, lecithin, modified starch, or gum Arabic, or a combination thereof.

Embodiment 30. The biodegradable microcapsule of any one of Embodiments 26-29, wherein the emulsion or agglomeration comprises one or more processing aids.

Embodiment 31. The biodegradable microcapsule of Embodiment 30, wherein the one or more processing aids comprise an antioxidant.

Embodiment 32. The biodegradable microcapsule of Embodiment 31, wherein the antioxidant is ascorbic acid, rosemary extracts, ascorbyl palmitate, tocopherols, or a mixture thereof.

Embodiment 33. The biodegradable microcapsule of any one of Embodiments 26-31, wherein the one or more processing aids comprise a transglutaminase enzyme.

Embodiment 34. A biodegradable microcapsule of any one of Embodiments 1-10, for use in a consumer product.

Embodiment 35. The biodegradable microcapsule of Embodiment 34, wherein the consumer product is a food, a beverage, a perfume, a deodorant, a detergent, a hand soap, a body wash, a moisturizer, a hairspray, a shampoo, a conditioner, a skin cream, or a lotion.

Embodiment 36. A biodegradable microcapsule comprising an inner core and a primary shell surrounding the inner core, wherein: (i) the inner core comprises a fragrance and/or flavor oil; and (ii) the primary shell comprises one or more food grade wall materials.

Embodiment 37. A biodegradable microcapsule comprising an inner core and a primary shell surrounding the inner core, wherein: (i) the inner core comprises a fragrance and/or flavor oil; and (ii) the primary shell comprises one or more food grade wall materials, produced by (A) providing an emulsion comprising a fragrance and/or flavor oil, one or more food grade wall materials, water, and, optionally, one or more processing aids; and (B) spray drying the emulsion to provide a dry powder comprising the microcapsule.

Embodiment 38. A biodegradable microcapsule comprising: (a) an agglomeration of primary microcapsules, wherein the primary microcapsules comprise an inner core and a primary shell surrounding the inner core; and (b) an outer shell surrounding the agglomeration of primary microcapsules, wherein: (i) the inner core comprises a fragrance and/or flavor oil; (ii) the primary shell comprises one or more food grade wall materials; and (iii) the outer shell comprises one or more food grade wall materials.

Embodiment 39. The biodegradable microcapsule of any one of Embodiments 36-38, wherein the food grade wall material comprises modified starch, gum arabic, gelatin, pectin, lecithin, casein, caseinate, whey protein isolates, pea protein isolates, soy protein isolates, egg protein, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof.

Embodiment 40. A method of preparing the biodegradable microcapsule of Embodiment 36, the method comprising: (i) providing an emulsion comprising a fragrance and/or flavor oil, one or more food grade wall materials, water, and, optionally, one or more processing aids; and (ii) spray drying the emulsion to provide a powder comprising the biodegradable microcapsule.

Embodiment 41. The biodegradable microcapsule of any one of Embodiments 36-39, or the method of Embodiment 40, wherein the fragrance and/or flavor oil is peppermint, vanilla, rose, jasmine, lavender, lemon, orange, mango, pineapple, lychee, raspberry, peach, strawberry, musk, or a combination thereof.

### VI. Definitions

Unless defined otherwise, all technical and scientific terms used herein have the same meaning as commonly understood by one of ordinary skill in the art to which this disclosure belongs. In case of conflict, the present application including the definitions will control. Unless otherwise required by context, singular terms shall include pluralities and plural terms shall include the singular

As used herein, the singular forms “a,” “an,” and “the” include plural references unless the context clearly dictates otherwise. For example, the term “a compound” or “at least one compound” may include a plurality of compounds, including mixtures thereof. The terms “a”, “an,” “the,” “one or more,” and “at least one,” for example, can be used interchangeably herein.

As used herein, the term “about,” means plus or minus 10% of the reported numerical value.

Various embodiments of this disclosure can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range, such as from 1 to 6 should be considered to have specifically disclosed subranges such as from 1 to 2, from 1 to 3, from 1 to 4, from 1 to 5, from 2 to 3, from 2 to 4, from 2 to 5, from 2 to 6, from 3 to 4, from 3 to 5, from 3 to 6, etc., as well as individual numbers within that range, for example, 1, 2, 3, 4, 5, and 6. This applies regardless of the breadth of the range.

Unless specifically stated or obvious from context, as used herein, the term “or” is understood to be inclusive. The term “and/or” as used in a phrase such as “A and/or B” herein is intended to include both “A and B,” “A or B,” “A,” and “B.” Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

The terms “comprises,” “comprising,” “includes,” “including,” “having,” and their conjugates are interchangeable and mean “including but not limited to.” It is understood that wherever aspects are described herein with the language “comprising,” otherwise analogous aspects described in terms of “consisting of” and/or “consisting essentially of” are also provided.

The term “consisting of” means “including and limited to.”

The term “consisting essentially of” means the specified material of a composition, or the specified steps of a method, and those additional materials or steps that do not materially affect the basic characteristics of the material or method.

The term “food grade” as used herein refers to material that is safe for human consumption.

The term “residue” as used herein refers to the moiety that is the resulting product of the specified chemical species in a particular reaction scheme or subsequent formulation or chemical product, regardless of whether the moiety is actually obtained from the specified chemical species. For example, an “amino acid residue” refers to the moiety which results when an amino acid participates in a particular reaction, e.g., the residue can be the product of an amino acid undergoing a transglutaminase catalyzed crosslinking reaction with another amino acid. In this case, the amino acid residue is “derived” from the amino acid. It is understood that this moiety can be obtained by a reaction with a species other than the specified amino acid, for example, by a reaction with a protein or peptide containing the amino acid, and the like. This concept applies to other chemical species disclosed herein, such as protein, saccharides like chitosan, lactose, and sucrose, and waxes. Thus, when such species undergo particular reactions or treatment, e.g., acid/base reactions, crosslinking reactions with other chemical species, and functional group transformations, they are referred to herein as a residue of the corresponding chemical species.

A weight percent (wt. %) of a component is based on the total weight of the composition in which the component is included.

### EXAMPLES

### Example 1

### Biodegradable Musk Oil-Loaded Microcapsules by Complex Coacervation

18 g of gelatin (>200 Bloom) was redispersed in 100 g of water (15% gelatin). The solution was heated to 40° C. 19.2 g of musk oil (˜61.5% payload) was added to the solution. The resulting suspension was emulsified with a POLYTRON® PT 6100 homogenizer at 15,000 rpm for 4 minutes. The resulting emulsion was examined under a microscope after emulsification to verify that the oil droplets were small and uniform (about 1-2 μm) in diameter. The emulsion was added to 480 g of distilled water in a 1 L reactor at a temperature of 40° C. The pH of the resulting mixture was measured. 2.0 g of polyphosphate (PP) was dissolved in 12 g of distilled water. This freshly prepared PP solution was then added to the diluted emulsion in the reactor. The pH of the mixture in the reactor and the size of the particles in the mixture were monitored. The pH of the mixture was lowered with 10% phosphoric acid to form agglomerations of primary microcapsules. The slurry was cooled to 4° C. with controlled cooling at a rate of 5° C. per minute and held at 4° C. for one hour. The pH was then raised to 5-6 with 10% NaOH solution. 1.24 g of transglutaminase dissolved in 3 g of distilled water was added to the microcapsules at 4° C. After 45 minutes at 4° C., the pH of the mixture was adjusted to 7, and the mixture was held an additional 45 minutes at 4° C. The temperature was then raised to 15° C. and held overnight to allow crosslinking to occur, and results a suspension of microcapsules that may be spray dried to produce the powder.

### Example 2

### Biodegradable Musk Oil-Loaded Microcapsules by Spray Drying

72 g of N-Lok® 1930 starch was redispersed in 180 g of distilled water and stirred at 340 rpm at room temperature for about 30 minutes. 31 g of musk oil was added to the suspension with stirring. The suspension was homogenized by a Pro Scientific homogenizer for 7 minutes at 15,000 rpm to produce an emulsion with most particles <1 μm in diameter. The emulsion was spray dried using a YAMATO® spray dryer. The resulting powder was packed using a vacuum sealer.

### Example 3

### Biodegradable Orange Oil-Loaded Microcapsules by Spray Drying

Redisperse 93.3 g of Gum Arabic into 279.9 g of DI Water with stirring. Redisperse 40 g of orange Oil into the above suspension with stirring. Homogenize the suspension via a Pro Scientific homogenizer with a chiller until the emulsion droplet size is ˜1 um. Spray-dry the suspension and pack the powder

### Example 4

### Biodegradable Orange Oil-Loaded Microcapsules by Complex Coacervation

1. 22.4 g of gelatin (>200 Bloom) is redispersed in 127 g of water (15% gelatin) at 40° C.
2. 589 g of DI water is added to a 1-L reactor and temperature is maintained at 40° C.
3. 36 g of orange oil is added to the gelatin suspension
4. The resulting suspension is emulsified with a Pro Scientific homogenizer to create a fine, uniform emulsion of ˜1 um in size.
5. The emulsion is added to the reactor and the pH is measured
6. 2.3 g of polyphosphate is dissolved in 15 g of DI water, then added to the reactor
7. The suspension pH is lowered with 10% phosphoric acid to form agglomerations of primary microcapsules (˜20 um). Overhead agitation speed is monitored throughout
8. Once microcapsules have reached the desired size, the suspension is cooled to 4° C.
9. Once the suspension has reached 4° C., the pH is adjusted to 6.0 using 10% NaOH, then the suspension is allowed to equilibrate for 1 hour
10. 1.55 g of transglutaminase is redispersed in 5 g of DI water, then added to the suspension. The pH is then adjusted to 7.0 using 10% NaOH and allowed to equilibrate for 1 hour
11. The temperature of the suspension is raised to 25° C. for overnight crosslinking
12. Spray-dry the suspension of microcapsules and collect the powder

### Example 5

### Biodegradable Flora Oil-Loaded Microcapsules by Spray Drying

1. Redisperse 61.25 g of Modified Corn Starch Hi Cap 100 (Ingreion, USA) in 142 mL of DI water in a double jacketed reactor with overhead stirring at 400 RPM for 10 minutes.
2. Then 17.5 g of Maltodextrin was added to the suspension and wait until the powder fully redispersed. The overhead stirrer was still set at 400 RPM
3. A mixture of 17.5 g of rose oil and 17.5 g of jasmine oil was prepared in a separate small beaker.
4. Set the reactor's overhead stirrer at the speed of 600 RPM. Then, the oil mixture was transferred to the reactor drop-by-drop by using plastic transfer pipette.
5. The suspension was emulsified via a Pro Scientific homogenizer at 12 k RPM for 4 minutes under controlled temperature via chiller reactor at 5° C. The observed emulsion size was 1 μm and below.
6. The emulsified mixture was then brought for spray drying.

### Example 6

### Biodegradable Floral Oil-Loaded Microcapsules by Complex Coacervation

1. 22.4 g of gelatin (>200 Bloom) is redispersed in 127 g of water (15% gelatin) at 40° C.
2. 589 g of DI water is added to a 1-L reactor and temperature is maintained at 40° C.
3. 36 g of a mixture of 17.5 g of rose oil and 17.5 g of jasmine oil is added to the gelatin suspension
4. The resulting suspension is emulsified with a Pro Scientific homogenizer to create a fine, uniform emulsion of ˜1 um in size.
5. The emulsion is added to the reactor and the pH is measured
6. 2.3 g of polyphosphate is dissolved in 15 g of DI water, then added to the reactor
7. The suspension pH is lowered with 10% phosphoric acid to form agglomerations of primary microcapsules (˜20 um). Overhead agitation speed is monitored throughout
8. Once microcapsules have reached the desired size, the suspension is cooled to 4° C.
9. Once the suspension has reached 4° C., the pH is adjusted to 6.0 using 10% NaOH, then the suspension is allowed to equilibrate for 1 hour
10. 1.55 g of transglutaminase is redispersed in 5 g of DI water, then added to the suspension. The pH is then adjusted to 7.0 using 10% NaOH and allowed to equilibrate for 1 hour
11. The temperature of the suspension is raised to 25° C. for overnight crosslinking
12. Spray-dry the suspension of microcapsules and collect the powder

### Example 7

### Biodegradable Lemon Oil-Loaded Microcapsules by Spray Drying

1. Redisperse 61.25 g of Modified Corn Starch Hi Cap 100 (Ingreion, USA) in 142 mL of DI water in a double jacketed reactor with overhead stirring at 400 RPM for 10 minutes.
2. Then 17.5 g of Maltodextrin was added to the suspension and wait until the powder fully redispersed. The overhead stirrer was still set at 400 RPM
3. 35 g of lemon oil was added to the reactor gradually under agitation.
4. The suspension was emulsified via a Pro Scientific homogenizer at 12 k RPM for 4 minutes under controlled temperature via chiller reactor at 5° C. The observed emulsion size was 1 μm or less.
5. Spray-dry the suspension and collect the powder

### Example 8

### Biodegradable Lavender Oil-Loaded Microcapsules by Spray Drying

1. Redisperse 122.5 g of Starch Corn Modified Hi Cap in 168 mL of DI water with overhead stirring around ˜400 RPM.
2. Add 35 g of Maltodextrin Corn 100DE to the suspension.
3. Add 70 g of lavender oil to the suspension.
4. Emulsify via a Pro Scientific homogenizer for 6 minutes at 12K RPM to produce a fine, uniform emulsion of ˜1 um in size with temperature control using a chilled jacketed reactor.
5. Spray-dry the suspension.

### Example 9

### Biodegradable Lavender Oil-Loaded Microcapsules by Complex Coacervation

1. 22.4 g of gelatin (>200 Bloom) is redispersed in 127 g of water (15% gelatin) at 40° C.
2. 589 g of DI water is added to a 1-L reactor and temperature is maintained at 40° C.
3. 36 g of lavender oil is added to the gelatin suspension
4. The resulting suspension is emulsified with a Pro Scientific homogenizer to create a fine, uniform emulsion of ˜1 um in size.
5. The emulsion is added to the reactor and the pH is measured
6. 2.3 g of polyphosphate is dissolved in 15 g of DI water, then added to the reactor
7. The suspension pH is lowered with 10% phosphoric acid to form agglomerations of primary microcapsules (˜20 um). Overhead agitation speed is monitored throughout
8. Once microcapsules have reached the desired size, the suspension is cooled to 4° C.
9. Once the suspension has reached 4° C., the pH is adjusted to 6.0 using 10% NaOH, then the suspension is allowed to equilibrate for 1 hour
10. 1.55 g of transglutaminase is redispersed in 5 g of DI water, then added to the suspension. The pH is then adjusted to 7.0 using 10% NaOH and allowed to equilibrate for 1 hour
11. The temperature of the suspension is raised to 25° C. for overnight crosslinking
12. Spray-dry the suspension of microcapsules and collect the powder

### Example 10

### Biodegradable Vanilla Oil-Loaded Microcapsules by Spray Drying

1. Redisperse 61.25 g of Modified Corn Starch Hi Cap 100 (Ingreion, USA) in 142 mL of DI water in a double jacketed reactor with overhead stirring at 400 RPM for 10 minutes.
2. Then 17.5 g of Maltodextrin was added to the suspension and wait until the powder fully redispersed. The overhead stirrer was still set at 400 RPM
3. 35 g of vanilla oil was added to the reactor gradually under agitation.
4. The suspension was emulsified via a Pro Scientific homogenizer at 12 k RPM for 4 minutes under controlled temperature via chiller reactor at 5° C. The observed emulsion size was 1 μm or less.
5. Spray-dry the suspension and collect the powder

### Example 11

### Biodegradable Pineapple Oil-Loaded Microcapsules by Spray Drying

1. Redisperse 61.25 g of Modified Corn Starch Hi Cap 100 (Ingreion, USA) in 142 mL of DI water in a double jacketed reactor with overhead stirring at 400 RPM for 10 minutes.
2. Then 17.5 g of Maltodextrin was added to the suspension and wait until the powder fully redispersed. The overhead stirrer was still set at 400 RPM
3. 35 g of pineapple oil was added to the reactor gradually under agitation.
4. The suspension was emulsified via a Pro Scientific homogenizer at 12 k RPM for 4 minutes under controlled temperature via chiller reactor at 5° C. The observed emulsion size was 1 μm or less.
5. Spray-dry the suspension and collect the powder

### Example 12

### Biodegradable Peach Oil-Loaded Microcapsules by Spray Drying

1. Redisperse 61.25 g of Modified Corn Starch Hi Cap 100 (Ingreion, USA) in 142 mL of DI water in a double jacketed reactor with overhead stirring at 400 RPM for 10 minutes.
2. Then 17.5 g of Maltodextrin was added to the suspension and wait until the powder fully redispersed. The overhead stirrer was still set at 400 RPM
3. 35 g of peach oil was added to the reactor gradually under agitation.
4. The suspension was emulsified via a Pro Scientific homogenizer at 12 k RPM for 4 minutes under controlled temperature via chiller reactor at 5° C. The observed emulsion size was 1 μm or less.
5. Spray-dry the suspension and collect the powder

### Example 13

### Biodegradable Peppermint Oil-Loaded Microcapsules by Spray Drying

1. Redisperse 175 g of Starch Corn Modified Hi Cap in 175 mL of DI water with overhead stirring around ˜400 RPM
2. Add 50 g of Maltodextrin Corn 10DE to the suspension
3. Add 100 g of Peppermint Flavor Key to the suspension
4. Emulsify the suspension with a Pro Scientific homogenizer for 6 minutes at 12K RPM to produce a fine, uniform emulsion droplet of ˜1 um in diameter
5. Spray-dry the suspension

### Example 14

### Biodegradable Mango Oil-Loaded Microcapsules by Spray Drying

1. Redisperse 61.25 g of Modified Corn Starch Hi Cap 100 (Ingreion, USA) in 142 mL of DI water in a double jacketed reactor with overhead stirring at 400 RPM for 10 minutes.
2. Then 17.5 g of Maltodextrin was added to the suspension and wait until the powder fully redispersed. The overhead stirrer was still set at 400 RPM
3. 35 g of mango oil was added to the reactor gradually under agitation.
4. The suspension was emulsified via a Pro Scientific homogenizer at 12 k RPM for 4 minutes under controlled temperature via chiller reactor at 5° C. The observed emulsion size was 1 μm or less.
5. Spray-dry the suspension and collect the powder

Having now fully described the methods, biodegradable microcapsules, and compositions herein, it will be understood by those of skill in the art that the same can be performed within a wide and equivalent range of conditions, formulations, and other parameters without affecting the scope of the methods, compounds, and compositions provided herein or any embodiment thereof. All patents, patent applications, and publications cited herein are fully incorporated by reference herein in their entirety.

1. A biodegradable microcapsule comprising:
(a) an emulsion or agglomeration of primary microcapsules, wherein the primary microcapsules comprise an inner core and a primary shell surrounding the inner core; and
(b) an outer shell surrounding the emulsion or agglomeration of primary microcapsules,
wherein:
(i) the inner core comprises a fragrance and/or flavor oil;
(ii) the primary shell comprises one or more food grade wall materials; and
(iii) the outer shell is produced by spray drying the emulsion or agglomeration.

2. The biodegradable microcapsule of claim 1, wherein the food grade wall material comprises modified starch, gum arabic, gelatin, pectin, lecithin, casein, caseinate, whey protein isolates, pea protein isolates, soy protein isolates, egg protein, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof.

3. The biodegradable microcapsule of claim 2, wherein the food grade wall material comprises gelatin, protein isolate, lecithin, modified starch, or gum Arabic, or a combination thereof.

4. The biodegradable microcapsule of claim 1, wherein the inner core, the primary shell, and/or the outer shell further comprise one or more processing aids.

5.-6. (canceled)

7. The biodegradable microcapsule of claim 1, wherein the primary shell and/or the outer shell comprises cross-linked food grade wall materials.

8. The biodegradable microcapsule of claim 1, wherein the primary shell and/or the outer shell comprises a complex coacervate of the food grade wall materials.

9. The biodegradable microcapsule of claim 1, wherein the diameter of the microcapsule is from about 1 μm to about 500 μm.

10. An emulsion comprising a fragrance and/or flavor oil, one or more food grade wall materials, and water.

11. The emulsion of claim 10, wherein the emulsion droplet size is about 2 μm or less.

12. The emulsion of claim 10, wherein the food grade wall material comprises modified starch, gum arabic, gelatin, pectin, lecithin, casein, caseinate, whey protein isolates, pea protein isolates, soy protein isolates, egg proteins, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof.

13. The emulsion of claim 12, wherein the food grade wall material comprises gelatin, protein isolate, lecithin, modified starch, or gum Arabic, or a combination thereof.

14.-16. (canceled)

17. A method of preparing the biodegradable microcapsule of claim 1, the method comprising:
(i) providing an emulsion or agglomeration comprising a fragrance and/or flavor oil, one or more food grade wall materials, water, and, optionally, one or more processing aids; and
(ii) spray drying the emulsion or agglomeration to provide a powder comprising the biodegradable microcapsule.

18. A method of preparing the biodegradable microcapsule of claim 1, the method comprising:
(i) providing an emulsion or agglomeration comprising a fragrance and/or flavor oil, water, and, optionally, one or more processing aids;
(ii) adjusting the pH, temperature, concentration, or mixing speed, or combination thereof, of the emulsion or agglomeration to form a coacervate slurry; and
(iii) spray drying the coacervate slurry to provide a powder comprising the microcapsule.

19. The method of claim 17, wherein the food grade wall material comprises modified starch, gum arabic, gelatin, pectin, lecithin, casein, caseinate, whey protein isolates, pea protein isolates, soy protein isolates, egg proteins, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof.

20. The method of claim 19, wherein the food grade wall material comprises gelatin, protein isolate, lecithin, modified starch, or gum Arabic, or a combination thereof.

21. The method of claim 17, wherein the emulsion comprises one or more processing aids.

22.-23. (canceled)

24. The method of claim 21, wherein the one or more processing aids comprise a transglutaminase enzyme.

25. A biodegradable microcapsule comprising:
(a) an emulsion or agglomeration of primary microcapsules, wherein the primary microcapsules comprise an inner core and a primary shell surrounding the inner core; and wherein:
(i) the inner core comprises a fragrance and/or flavor oil; and
(ii) the primary shell comprises one or more food grade wall materials;
wherein the biodegradable microcapsule is produced by spray drying the emulsion or agglomeration to provide a dry powder comprising the microcapsule.

26. A biodegradable microcapsule comprising:
(a) an emulsion or agglomeration of primary microcapsules, wherein the primary microcapsules comprise an inner core and a primary shell surrounding the inner core; and
(b) an outer shell surrounding the agglomeration of primary microcapsules, wherein:
(i) the inner core comprises a fragrance and/or flavor oil;
(ii) the primary shell comprises one or more food grade wall materials; and
(iii) the outer shell comprises one or more food grade wall materials,
produced by adjusting the pH, temperature, concentration, or mixing speed, or combination thereof, of the emulsion or agglomeration to form a coacervate slurry; and spray drying the coacervate slurry to provide a powder comprising the microcapsule.

27. The biodegradable microcapsule of claim 25, wherein the food grade wall material comprises modified starch, gum arabic, gelatin, pectin, lecithin, casein, caseinate, whey protein isolates, pea protein isolates, soy protein isolates, egg proteins, yeast protein, algae protein, hempseed protein, rice protein, barley protein, pumpkin seed protein, almond protein, canola protein, plant-based proteins, insect based proteins, xanthan gum, gellan gum, polyphosphate, alginate, agar, carrageenan, starch, oligofructans, konnyaku, alpha-lactalbumin, beta-lactoglobumin, ovalbumin, polysorbate, maltodextrin, alpha-cyclodextrins, beta-cyclodextrins, gamma-cyclodextrins, chitosan, chitin, cellulose, methyl cellulose, ethyl cellulose, hydropropylmethyl cellulose, carboxymethylcellulose, hydroxypropyl cellulose, canola protein, albumin, poly-lysine, dilutan gum, locus bean gum, or Welan gum, or a combination thereof.

28. The biodegradable microcapsule of claim 27, wherein the food grade wall material comprises gelatin, protein isolate, lecithin, modified starch, or gum Arabic, or a combination thereof.

29. The biodegradable microcapsule of claim 25, wherein the emulsion or agglomeration comprises one or more processing aids.

30.-31. (canceled)

32. The biodegradable microcapsule of claim 29, wherein the one or more processing aids comprise a transglutaminase enzyme.

33. The biodegradable microcapsule of claim 1, wherein the fragrance and/or flavor oil is peppermint, vanilla, rose, jasmine, lavender, lemon, orange, mango, pineapple, lychee, raspberry, peach, strawberry, musk, or a combination thereof.

34. The emulsion of claim 10, wherein the fragrance and/or flavor oil is peppermint, vanilla, rose, jasmine, lavender, lemon, orange, mango, pineapple, lychee, raspberry, peach, strawberry, musk, or a combination thereof.

35. The method of claim 17, wherein the fragrance and/or flavor oil is peppermint, vanilla, rose, jasmine, lavender, lemon, orange, mango, pineapple, lychee, raspberry, peach, strawberry, musk, or a combination thereof.

36. The biodegradable microcapsule of claim 25, wherein the fragrance and/or flavor oil is peppermint, vanilla, rose, jasmine, lavender, lemon, orange, mango, pineapple, lychee, raspberry, peach, strawberry, musk, or a combination thereof.

37. The biodegradable microcapsule of claim 1, wherein the outer shell can be added by coating the emulsion or agglomeration with one or more food grade wall materials.

38. The method of claim 17, wherein the microcapsule is further coated by a food grade material to add an additional outer shell.

39. The biodegradable microcapsule of claim 25, wherein the biodegradable microcapsule is further coated by a food grade material to add an additional outer shell.
